(19) United States
(12) Patent Application Publication
(10) Pub. No.: US 2017/0243181 A1
(43) Pub. Date: Aug. 24, 2017

(54) METHODS AND SYSTEMS FOR REPLACING A PRIMARY ACCOUNT NUMBER (PAN) WITH A UNIQUE IDENTFIER

(71) Applicant: MasterCard International Incorporated, Purchase, NY (US)

(72) Inventors: John M. Tyma, O'Fallon, MO (US); Lorrie Littlefield, Chesterfield, MO (US); Christina M. Wehmeier, Chesterfield, MO (US); Patrick Allen Abbott, St. Peters, MO (US)

(21) Appl. No.: 15/051,921

(22) Filed: Feb. 24, 2016

(51) Int. Cl. G06Q 20/10; G06Q 20/40

(52) U.S. Cl. CPC G06Q 20/108; G06Q 20/401

(57) ABSTRACT

Methods, systems and apparatus relate to remittance transactions wherein a recipient's primary account number (PAN) is replaced with a unique identifier that reduces PCI data at-rest compliance requirements for a remittance network while also containing static information that permits cardholder account level tracking. In an embodiment, a sending remittance system computer receives a remittance payment request with a remittance amount, a currency type, and a recipient's PAN. The sending remittance system computer validates the request, transmits the recipient's PAN to a unique identifier service computer, receives a unique identifier having a static portion and a unique identification portion, generates a remittance payment transaction request, and transmits the remittance request to a network partner system computer.

### FIELD OF THE INVENTION

The present disclosure generally relates to methods, systems and apparatus for replacing a cardholder's primary account number (PAN) with a unique identifier during a remittance transaction. More particularly, disclosed embodiments relate to remittance transactions wherein a recipient's PAN is replaced with a unique identifier that reduces PCI data at-rest compliance requirements for a remittance network while also still containing enough information to allow for cardholder account level tracking.

### BACKGROUND

Many people regularly send money to family or friends and a large portion of these remittances are across international borders. Formal commercial remittance channels (i.e., provided by banks and/or transfer agencies such as Western Union™) are generally labor-intensive and can be expensive to use. In addition, senders and recipients of remittances frequently find conventional remittance channels to be time-consuming and inconvenient. Thus, informal channels for remittances have appeared, but these are also labor-intensive and may not provide adequate protection for the funds that are being remitted. Although many of the people who make or receive international remittances are not wealthy and can ill-afford to risk losing money by using informal remittance channels, the high cost of transferring funds through banks and/or transfer agencies makes informal remittance channels attractive.

From a policy perspective, it is important to reduce money transfer costs in order to increase the amount of remittances returning through formal channels. In particular, remittances sent through official banking channels can facilitate financial sector development in developing countries in a number of ways: (1) as bank deposits from remittances increase, banks are able to make more loans; (2) remittance receivers who use banks can gain access to other financial products and services; and (3) banks that provide remittance transfer services are able to “reach out” to unbanked recipients and those with limited financial intermediation.

It is important to recognize that international remittances raise issues related to governmental security and anti-crime interests. Thus, many countries have regulations in place concerning international funds transfers, to aid in efforts to combat funding of terrorist groups and organized crime. These types of regulations are generally referred to as “anti-money laundering” (AML) provisions, and typically require that financial institutions and remittance service providers (RSPs) have “know your customer” (KYC) provisions in place that require them to gather and/or otherwise obtain certain required information about their customers. Compliance with KYC and AML regulations may place significant cost and administrative burdens on formal international remittance channels, which costs are typically passed on to the users of the remittance channels.

U.S. Published Application 2013/0282585 discloses an international remittance system based on an international payment card system such as that operated by MasterCard International Incorporated (the applicant hereof) and its member financial institutions, and the content thereof is hereby incorporated by reference. Aspects of the present disclosure extend the benefits of such a system to remittance senders who are payment card account holders (cardholders) and to remittance recipients, including remittance recipients who do have and who do not have payment card accounts.

The Payment Card Industry Data Security Standard (PCI DSS) is a set of requirements designed to ensure that all companies that process, store or transmit credit card information maintain a secure environment, and is administered by the Payment Card Industry Security Standards Council (PCI SSC), which is an independent body created by the major payment card processing companies. The PCI DSS applies to any organization or merchant, regardless of size or number of transactions, that accepts, transmits or stores any cardholder data. Thus, an organization that utilizes cardholder data to transfer funds via an international remittance system based on an international payment card system is subject to the PCI DSS. The term “cardholder data” includes the full Primary Account Number (PAN) of payment card account holders, or the full PAN along with any of the following elements: the cardholder's name, card account expiration date, and/or service code data. In addition, sensitive authentication data must also be protected, which includes information such as full magnetic stripe data, credit card security codes (such as CAV2, CVC2, CVV2, and CID codes), personal identification numbers (PINs), PIN blocks and more. Non-compliance with PCI DSS may subject an organization or company or merchant to fines, card replacement costs, costly forensic audits, brand damage and the like should a breach event occur.

Thus, every business that handles the financial data of their customers is looking for ways to limit the scope of their PCI data requirements in order to minimize the cost, effort and risk that comes with complying with the PCI standards. In particular, the less payment information that an organization or business holds, the less the organization needs to do to convince a Qualified Security Assessor (QSA) or acquiring bank that the business is PCI compliant. One method for reducing the PCI requirements impact is to use “tokenization,” which pertains to the process of swapping highly-sensitive personal payment account data (i.e., a customer's primary account number (PAN)) for a “token,” which includes a number of random digits that cannot be restored back to their original value by a person or entity that is not a party to the transaction.

Tokens are typically provisioned by a Token Service Provider (TSP), and each token is composed of a token number that is associated with a particular consumer's or cardholder's PAN. A cardholder may then use his or her credit card (or payment-enabled mobile device) to pass the token and payment information to, for example, a merchant's point-of-sale (POS) terminal during a purchase transaction. A payment authorization request is then originated from the POS terminal and routed via an acquiring financial institution to the TSP. The authorization request includes the token and other transaction information (but not the PAN). In some implementations, the TSP maintains a secure database (or “token vault”) that is used to map a received token to an associated PAN of the cardholder. Thus, in the above example, upon receipt the TSP replaces the token with the corresponding PAN (which the token represents) and then routes the purchase transaction authorization request (which now includes the PAN and other information such as the transaction amount) to the issuer of the payment card account identified by the PAN. A similar tokenization process can be followed when a cardholder initiates a remittance transaction to send funds to a recipient who may or may not have a payment card account. However, the tokens utilized in such purchase and/or remittance transactions are typically designed to be used only once, which does not permit the application of account level controls and/or tracking.

Accordingly, there is a need for a technical solution to the problem of how to generate and/or provide a unique identifier to replace a cardholder's PAN that not only reduces the PCI compliance requirements associated with accepting, processing, and storing PAN data, but that also contains enough consistent information to allow cardholder account level controls and/or tracking.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram illustrating an example of a remittance system in accordance with some aspects of the disclosure;

FIG. 2A depicts an example of a payment card having a sixteen (16) digit payment card account number (PAN);

FIG. 2B illustrates an example of a unique identifier generated by a unique identifier service using portions of the PAN of FIG. 2A in accordance with methods described herein;

FIG. 2C is a transaction work flow diagram illustrating a remittance transaction process between a sender and a recipient via a network partner system in accordance with the disclosure;

FIG. 3 is a flow diagram illustrating a process for transmitting a remittance payment between a sender and a recipient who have payment card accounts in accordance with some aspects of the disclosure; and

FIG. 4 is a flow diagram illustrating a process wherein a remittance network is configured for conducting a remittance transaction in accordance with the disclosure.

### DETAILED DESCRIPTION

In general, and for the purpose of introducing concepts of embodiments of the present disclosure, systems, apparatus and methods are disclosed for replacing a cardholder's primary account number (PAN) with a unique identifier during a remittance transaction. More particularly, disclosed embodiments relate to remittance transactions wherein the PAN of a recipient of the remittance (who is a payment card account holder) is replaced with a unique identifier that contains enough information to allow for cardholder account level tracking, but which also reduces PCI compliance requirements for a remittance network.

In some embodiments, during a remittance transaction a unique identifier service replaces a sixteen to nineteen (16-19) digit primary account number (PAN) of a recipient cardholder with a unique value for the purpose of reducing the PCI regulatory overhead associated with accepting, processing, and storing PAN data. The unique identifier service creates an identification value that is unique for each remittance transaction, but that also contains enough consistent information (associated with the recipient's PAN and that survives from one remittance transaction to the next) to allow for velocity and other account level tracking measures. For example, individual transaction amounts for a particular cardholder account can be validated against anti-money laundering (AML) limits (for example, a particular cross border transaction for a cardholder account may have a two-thousand and five hundred dollar AML limit (a $2,500.00 AML limit). In addition, multiple transactions involving a particular cardholder account can be monitored over time and a cumulative transaction amount generated. The cumulative transaction amount can then be validated against AML limits (for example, an amount of money sent to or from a particular cardholder account over the course of a predetermined period of time, such as one month, cannot exceed and AML limit of ten thousand dollars (an AML limit of $10,000.00). Servicing for current and/or future account-level value added services, such as rewards programs for valued and/or repeat customers, can advantageously be supported. Moreover, products or merchandise and/or customer-specific reporting can be supported because all transactions for a specific cardholder and/or sender can be accumulated and reports can be generated. The reports may be provided to participants such as issuers and/or merchants for a fee or as part of the overall service.

Therefore, although each identification value is unique, at least one portion of the unique identification value for a particular PAN is static or the same each time that a specific payment card account associated with a recipient (a particular PAN) is used in a remittance transaction. In some embodiments, a unique identifier service (which generates the unique identifier) is called from within a process or application (i.e., as part of the remittance flow), while in other embodiments the unique identifier service is called via a service call request (i.e., to a standalone service computer or service computer network that is not tied to remittance transactions) that generates the unique identifier. Thus, in some embodiments the unique identification value (or unique identifier) includes a static portion and a dynamic portion (or a unique identification portion).

A number of terms are used herein. For example, the term “tokenize” and/or “tokenization” as used herein refers to providing a token or other identification number that is associated with a consumer's primary account number (PAN) in accordance with novel disclosed aspects. In addition, the term “payment card network” or “payment network” as used herein refers to a payment network or payment card network or payment system operated by a payment processing entity, such as MasterCard International Incorporated, or other networks which process payment transactions on behalf of a number of merchants, issuers and payment account holders (such as credit card account and/or debit card account and/or loyalty card account holders, commonly referred to as cardholders or payment account holders). Moreover, the terms “payment card network data” or “network transaction data” or “payment network transaction data” refer to transaction data associated with remittance and/or payment and/or purchase transactions that have been or are being processed over a payment network. For example, network transaction data may include a number of data records associated with individual payment transactions (or purchase transactions) of cardholders that have been processed or are being processed over a payment card network. In some embodiments, network transaction data may include information that identifies a cardholder, a payment device and/or payment account (such as a credit card or debit card account), a transaction date and time, a transaction amount, items and/or services that have been purchased, information identifying a remittance recipient, and/or information identifying a merchant and/or a merchant category. Additional transaction details may also be available in some embodiments.

Examples of embodiments related to replacing a recipient's primary account number (PAN) with a unique identifier during a remittance transaction are illustrated in the drawings and accompanying text, and it should be understood that the drawings and descriptions thereof are not intended to limit the invention to any particular embodiment(s). On the contrary, the descriptions provided herein are intended to cover alternatives, modifications, and equivalents thereof. Thus, although numerous specific details are set forth in order to provide a thorough understanding of the various embodiments, some or all of these embodiments may be practiced without some or all of the specific details. In other instances, well-known process operations have not been described in detail in order not to unnecessarily obscure novel aspects.

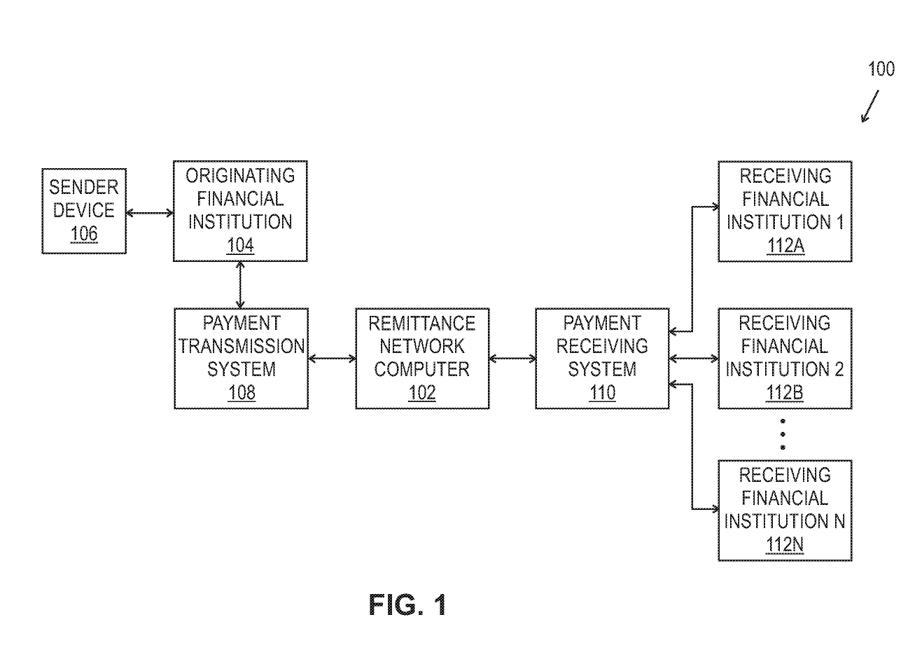

FIG. 1 is a block diagram illustrating an example of a remittance system 100 in accordance with some aspects of the disclosure. At the heart of the remittance system 100 is a remittance network computer 102, which operates to route and clear funds transfers from the payment card accounts of senders to the payment card accounts (or other financial accounts) of recipients. In some embodiments, the remittance network computer 102 interlinks numerous financial institutions of various countries around the world. In practice, the remittance system 100 may include many financial institutions (such as banks) that act as issuers of payment card accounts for senders and/or recipients of funds transfers. For ease of understanding, however, only one originating financial institution (FI) computer 104 is shown. Also depicted are a payment transmission system 108 configured for communications with the originating FI computer 104 and the remittance network computer 102, a payment receiving system computer 110, and a plurality of receiving financial institution computers 112A, 112B to 112N. As shown, the payment receiving system computer 110 is configured for communications with the remittance network computer 102 and with the plurality of receiving FI computers 112A-112N. It should be understood that the various blocks or components of the remittance system shown in FIG. 1 may include or be comprised of one or more computers, computer networks, and/or computer systems. Furthermore, although the various components of the remittance transaction system 100 are shown as being connected directly to each other, other types of interconnections, such as via the Internet or via other types of wired or wireless networks and/or network connections, including proprietary and/or secure network connections, are contemplated.

Referring again to FIG. 1, in some embodiments a sender (a cardholder and a member of the remittance system) requests a remittance transaction be made to send money to a recipient (another cardholder) by using a consumer mobile device or sender device 106 to transmit a remittance request to the originating FI computer 104. Originating FIs (associated with senders) and recipient FIs (associated with recipients) are members of the payment transmission and/or payment receiving systems (which may both be owned and/or operated by an entity, such as a payment processing organization like MasterCard International Incorporated). Thus, in some implementations, the payment transmission and/or payment receiving systems have agreements or contracts with the sending and receiving institutions, and operate in accordance with a Business-to-Business model. One the sending side of the process, the sending entity contracts with a network partner, whereas the receiving entity (the recipient's payment card issuer) contracts with a payment processing organization, such as MasterCard International Incorporated or other payment processing network (such as Visa Incorporated).

The sender device 106 shown in FIG. 1 may be any type of device suitable for performing the functions disclosed herein, and may include for example, a personal computer or a laptop computer or a payment-enabled mobile device, which may be a Smartphone, a smart watch (or any other type of “wearable” electronic device), a tablet computer, a digital music player, and/or a personal digital assistant (PDA) and the like. In some implementations, however, the cardholder may instead utilize a credit card or debit card with a magnetic stripe to request the remittance transaction, for example, by visiting the originating financial institution (FI) and swiping a credit or debit card through a reader device. In other embodiments, the cardholder may visit an originating FI and use a proximity payment device by tapping it on (or bringing it near) a proximity reader. In some embodiments, the remittance request includes the primary account number (PAN) of the recipient and the amount of money to remit to the recipient.

Referring again to FIG. 1, after receiving the remittance request the originating FI computer 104 transmits it to the payment transmission system 108. In some embodiments, the payment transmission system 108 calls a tokenization service or unique identifier service (not shown) which responds by using the recipient's primary account number (PAN) to generate a unique identifier. Upon receipt of the unique identifier, the payment transmission system 108 generates a remittance payment transaction request that includes the unique identifier, remittance amount, and the currency type and transmits the remittance payment request to the remittance network computer 102. In some implementations, the remittance network computer 102 receives and processes the remittance payment request and applies velocity limits to a token portion of the unique identifier, and also stores the unique identifier with the payment details. The remittance network computer 102 also formats a payment transaction which includes providing the unique identifier received in the remittance payment request as the receiving account, and submits the payment transaction to the payment receiving system 110. Upon receiving the payment request, the payment receiving system 110 uses the information within the unique identifier to look up the original sixteen to nineteen (16-19) digit PAN of the recipient, and then places that PAN into a payment transaction request (in place of the unique identifier). The payment transaction request is then passed to an appropriate receiving FI (based on information in the original PAN), for example, the receiving FI 112A (which is the issuer FI of the recipient's payment card account) for processing. When the payment receiving system 110 receives the response from the receiving FI 112A, it transmits a remittance response to the remittance network computer 102. The remittance network computer 112 then updates its systems with the information of the remittance response and also provides it to the payment transmission system 108. Upon receipt of the remittance response, the payment transmission system 108 replaces the unique identifier with the originally provided PAN of the recipient and provides a remittance confirmation response to the originating FI 104. The originating FI then provides the remittance confirmation response to the sender device 106 to confirm the remittance transaction.

In some embodiments, the financial institutions (FIs) 104 and 112A-112N (and all other FIs that may be included in the remittance system 100 but are not depicted) are banks and/or other entities and/or organizations that are subject to regulation(s) to assure compliance with know-your-customer (KYC) and anti-money laundering (AML) requirements. In addition, those FIs have internal procedures in place to comply with such KYC and AML requirements so as to satisfy local and/or national government and/or regulatory agency requirements. Consequently, upon or prior to opening a payment card account for a customer, each of the FIs gathers information about that customer, such as the customer's full name, residential address and/or other identifying information and/or data. Customary procedures may also call for the FI to obtain documentary proof of the customer information, such as a valid driver's license, a photocopy of a passport, and/or an identity card or other government identification card which contains a photograph of the customer, and the like. To demonstrate compliance with the documentation procedures, the FIs may also keep an image of any or all of the document(s) provided by the customer and used to establish the customer's identity and/or residence address. As mentioned earlier, the processes disclosed herein permit the FIs to monitor individual transaction amounts for a particular cardholder account, and also to monitor multiple transactions involving that particular cardholder account over time and a cumulative transaction amount generated. The individual transaction amounts and the cumulative transaction amount can then be validated against AML limits to ensure compliance. FIs can also keep track of individual cardholder transaction amount data in order to service current and/or future account-level value added services, such as rewards programs for valued and/or repeat customers. Moreover, in some implementations, FIs can track purchases of specific products or merchandise and/or services.

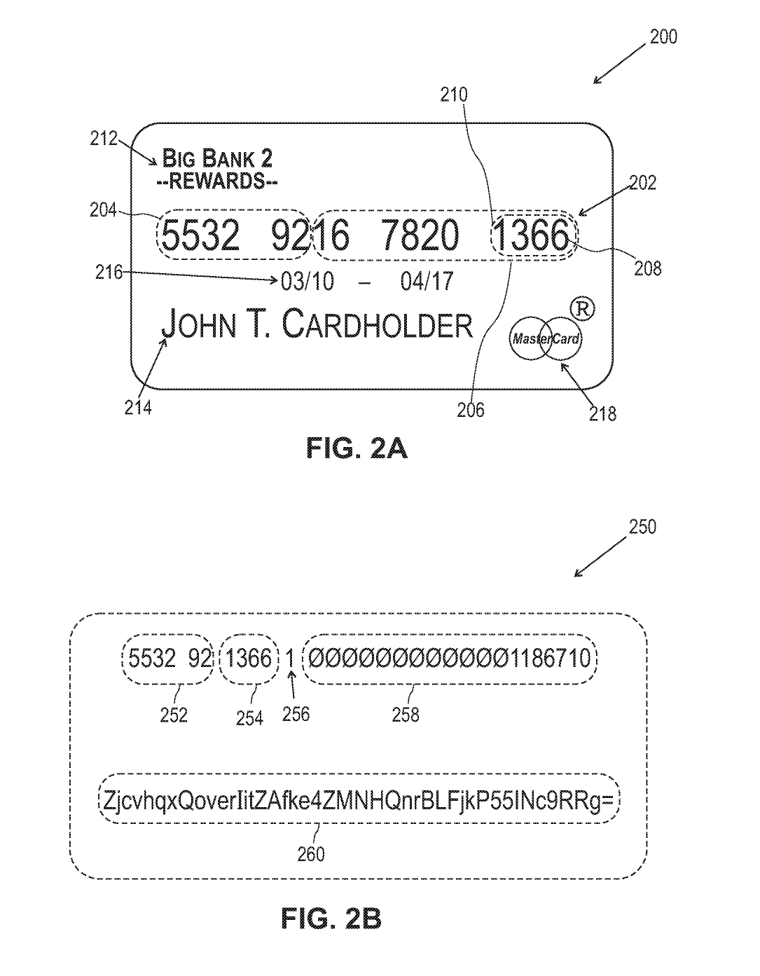

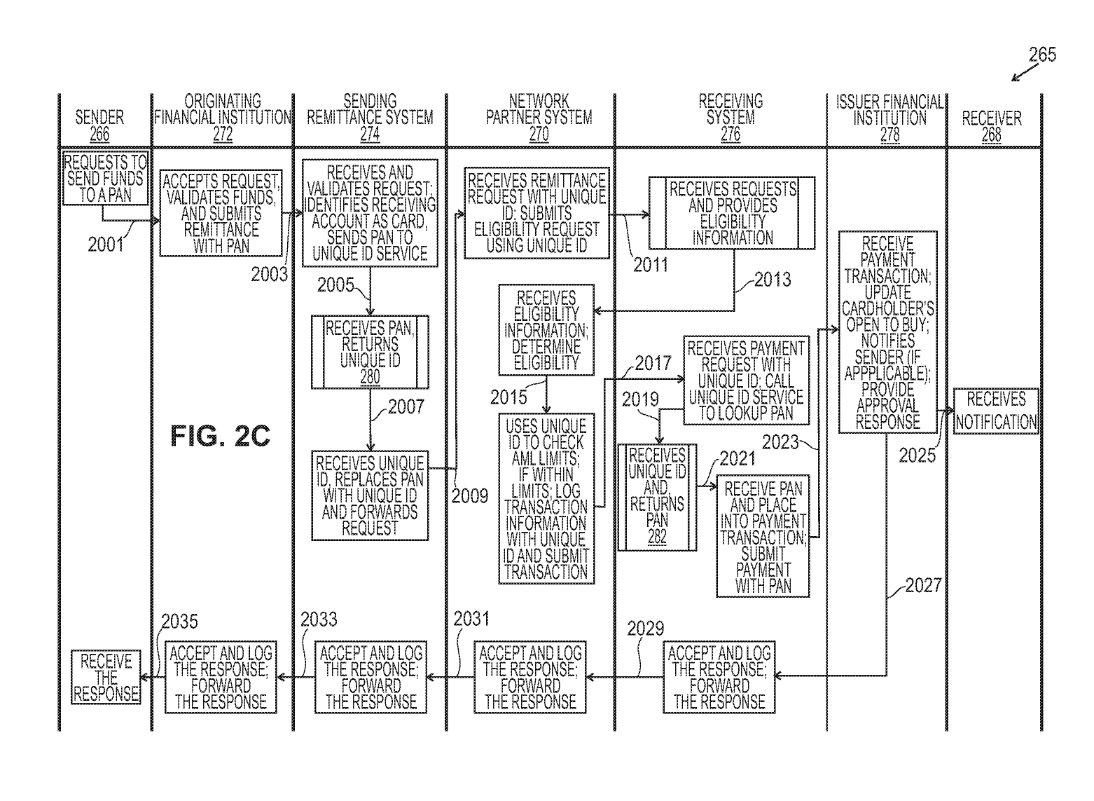

FIG. 2A depicts an example of a payment card 200 (which may be a magnetic stripe card or a proximity payment card, sometimes called a “chip card” or “smart card”) having a sixteen (16) digit payment card account number or PAN 202. In the case of the payment card 200 being associated with a recipient of a remittance transaction, in accordance with processes disclosed herein, during the remittance transaction the PAN 202 is replaced with a unique identifier 250 that is shown in FIG. 2B. As depicted in FIG. 2A, the sixteen (16) digit Primary Account Number (PAN) 202 may be printed and/or embossed on a front face of the card (but in the case of a consumer mobile device, the PAN 202 is typically not visible as it is not printed on the device and is otherwise not displayed during a purchase or remittance transaction). As also shown in FIG. 2A, it is common to have additional identifying features present and/or shown on the face of the payment card 200, such as an issuer bank's name 212, the cardholder's name 214, an expiration date 216, and a payment card processor's insignia 218 (which typically is a registered trademark). However, one or more of such identifying features may not be included on the front face of the card in some implementations, and such identifying features are typically not displayed on the surface or face of a consumer mobile device (such as a Smartphone) that is configured for conducting remittance transactions.

Referring again to FIG. 2A, in some implementations the first six (6) digits 204 of the PAN 202 identify the issuer financial institution (FI) of the payment card account (for example, an issuer bank, and thus the first six digits are sometimes referred to as a bank identification number (BIN)), and the next ten digits 206 are used to identify the cardholder's account, wherein the final digit 208 (six (“6”) in the example depicted in FIG. 2A) is typically a check digit. It is noted that, in many implementations, the last four digits 210 of the PAN (in this example, the number “1366”) are utilized for post-transaction identification purposes.

FIG. 2B illustrates an example of a unique identifier 250 generated by a unique identifier service (not shown) using various portions of the PAN 202 of FIG. 2A in accordance with methods described herein. In particular, the first six digits 252 of the unique identifier 250 are the same as the first six digits 204 of the recipient's PAN 202 shown in FIG. 2A (and thus, for a remittance transaction are equal to the bank identification number (BIN) of the PAN of the recipient's payment card account). The next four digits 254 are the same as the last four digits 210 of the PAN 202, and the next digit 256 (the eleventh digit), which is “1” in this example, is equal to a version number of the unique identification service. Thus, these three portions (252, 254 and 256) of the unique identifier 250 remain the same or are static from one transaction to the next. The next nineteen digits comprise the unique identification portion 258, which is associated with the request identifier (request ID) of the transaction. The unique identification portion 258 generated by the unique identifier service is what makes each remittance request unique because it changes (and is thus dynamic) from one transaction to the next. In some embodiments, the unique identifier service may utilize a random number generator or another means or process to dynamically generate the unique identification portion 258. For example, in some implementations the unique number may be based on a time stamp associated with the transaction.

Referring again to FIG. 2B, the last portion 260 is the token value created for the PAN 202 itself, and this value 260 is static or remains unchanged for the PAN 202 every time the PAN 202 is utilized for a remittance and goes through the unique identification service. Consequently, it is the unique identifier 258 portion of the overall unique identifier 250 that makes the overall token (which replaces the recipient's PAN 202) unique for each remittance transaction and thus secure, whereas the elements (252, 254, 256 and 260) of the token are static (or unchanged or the same) from one transaction to the next. Thus, it is the unchanged portions and/or static portions (252, 254, 256 and 260) which provide consistent or static information to allow for velocity and other account level tracking operations, whereas it is the unique portion (or dynamic portion) 258 which makes each remittance request unique.

FIG. 2C is a transaction work flow diagram 265 illustrating a remittance transaction process between a sender 266 and a recipient 268 via a network partner system 270 in accordance with embodiments described herein. In particular, the remittance process involves generating and utilizing a unique identifier that reduces the PCI compliance requirements of the network partner system 270 which are associated with accepting, processing, and storing PAN data. In addition, the unique identifier includes or contains enough consistent information (or persistent data) to allow cardholder account level controls and/or tracking to be possible from one transaction to the next transaction. In some embodiments, both the sender 266 and the receiver 268 (or recipient) are associated with financial institutions (FIs) that are members of the remittance and receiving system being used for the transaction, and a network partner system 270 is utilized to conduct remittance transactions. Such remittance transactions may be across country borders (known as “cross-border” transactions) or entirely within one country, and thus in some cases anti-money laundering (AML) and/or know-your customer (KYC) requirements can apply along with the requirement(s) to satisfy PCI standards. The member FIs each have agreements with the remittance and receiving system to participate as a sender and/or as a receiver. For example, with reference to FIG. 2C, the sending remittance system 274 and the receiving system 276 are both owned and/or operated by the same entity (such as a payment card processor like MasterCard International Incorporated), and thus the Originating FI 272 and the Issuer FI 278 each have an agreement with the payment card processor that operates both the sending remittance computer system 274 and the receiving computer system 276.

Referring again to FIG. 2C, a sender 266 transmits 2001 a remittance request to send funds to a primary account number (PAN) of a recipient. The originating FI 272 accepts the remittance request, validates the request by, for example, checking that the sender has adequate funds to cover the cost of the transfer of funds, and transmits 2003 a remittance request with the PAN of the recipient to the sending remittance system computer 274. The sending remittance system computer 274 receives and validates the request, identifies the recipient's account as a payment card account, and then transmits 2005 the recipient's PAN to a tokenization service 280, which may be an application program. The tokenization service 280 receives the PAN and returns 2007 a unique identifier in accordance with the processes described herein with regard to FIGS. 2A and 2B. In particular, in some embodiments the unique identifier includes an initial six digits that are the same as the first six digits of the recipient's PAN, a next four digits that are the same as the last four digits of the recipient's PAN, a next digit equal to a version number of the unique identification service, and nineteen additional digits representing a unique identification portion for the remittance transaction, which unique identification portion is associated with the request identifier (request ID) of the transaction. The tokenization service 280 then replaces the recipient's PAN with the unique identifier and transmits 2009 a remittance request to the network partner system computer 270.

The network partner system 270 receives the remittance request with the unique identifier, and then transmits 2011 an eligibility request to the receiving system 276 that includes the unique identifier (including a portion that indicates the BIN of the recipient's FI) and that may also include other information, for example, the currency type and monetary amount of the remittance. After receiving the eligibility request, the receiving system 276 transmits 2013 the eligibility information to the network partner system 270, which then determines whether the recipient's account is eligible for receiving the remittance transaction. Such a determination may be made, for example, by comparing the first six digits of the unique identifier (which is the bank identification number (BIN) of the recipient's account) to a list of eligible financial institutions (FIs). If the recipient's account is not eligible for receiving payment from the sender, then in some embodiments, the network partner system computer transmits (not shown) a remittance request denied message to the sending remittance system which then notifies the originating financial institution. But when a determination is made that the recipient's account is eligible, then the network partner system 270 utilizes the unique identifier and other information included in the remittance request to check whether the transaction amount is within anti-money laundering (AML) limits for the recipient's account. In the situation wherein the transaction amount is not within AML limits for the recipient's account (or otherwise runs afoul of AML regulations), then further processing (which may include, for example, notification of financial authorities and/or government authorities) may occur, which is not shown. In some cases, the remittance transaction is terminated or otherwise suspended until a determination can be made regarding whether or not to allow the transaction, but such processing is outside the scope of the present application and is thus not discussed further herein.

Referring again to FIG. 2C, in the case where the remittance transaction is within the AML limits for the recipient's account, then the network partner system logs the transaction with the unique identifier and transmits 2017 the transaction request to the receiving system 276. In accordance with methods described herein, the PCI standard requirements of the network partner system 270 are reduced or minimized because the network partner system 270 does not handle or utilized the actual PAN of the recipient's payment card account. Instead, from the point of view of the network partner system 270, the remittance transaction is processed solely with the unique identifier.

Referring again to FIG. 2C, when the receiving system 276 receives the payment request with the unique identifier, it calls 2019 a Unique identifier service 282, which may be a service application, to lookup the PAN of the recipient's payment card account (or otherwise translate the unique identifier into the recipient's PAN). The Unique identifier service 282 returns 2021 the recipient's PAN to the receiving system 276. The receiving system 276 next replaces the unique identifier in the payment request with the recipient's PAN and then transmits 2023 that payment request to the issuer FI (which issued the recipient's payment card account) for payment transaction processing. The issuer FI receives the payment transaction request which includes the recipient's PAN, updates its' cardholder's (the recipient's) open to buy information (i.e., credits the recipient's payment card amount for the payment amount), notifies 2025 the recipient or receiver 268 (recipient cardholder) of the payment, and in some implementations notifies the sender 266 (not shown) as well. The issuer FI 278 also transmits 2027 an approval response to the receiving system 276 which accepts and logs the approval response, and then forwards 2029 the approval response to the network partner system 270. The network partner system 270 also accepts and logs the approval response, and then forwards 2031 the approval response to the sending remittance system 274. The sending remittance system 274 then accepts and logs the approval response, and next forwards 2033 the approval response to the originating FI 272, which accepts and logs the approval response. The originating FI 272 then transmits 2035 the approval response to the sender 266 so that the sender knows that the remittance payment has been received by the recipient or receiver 268.

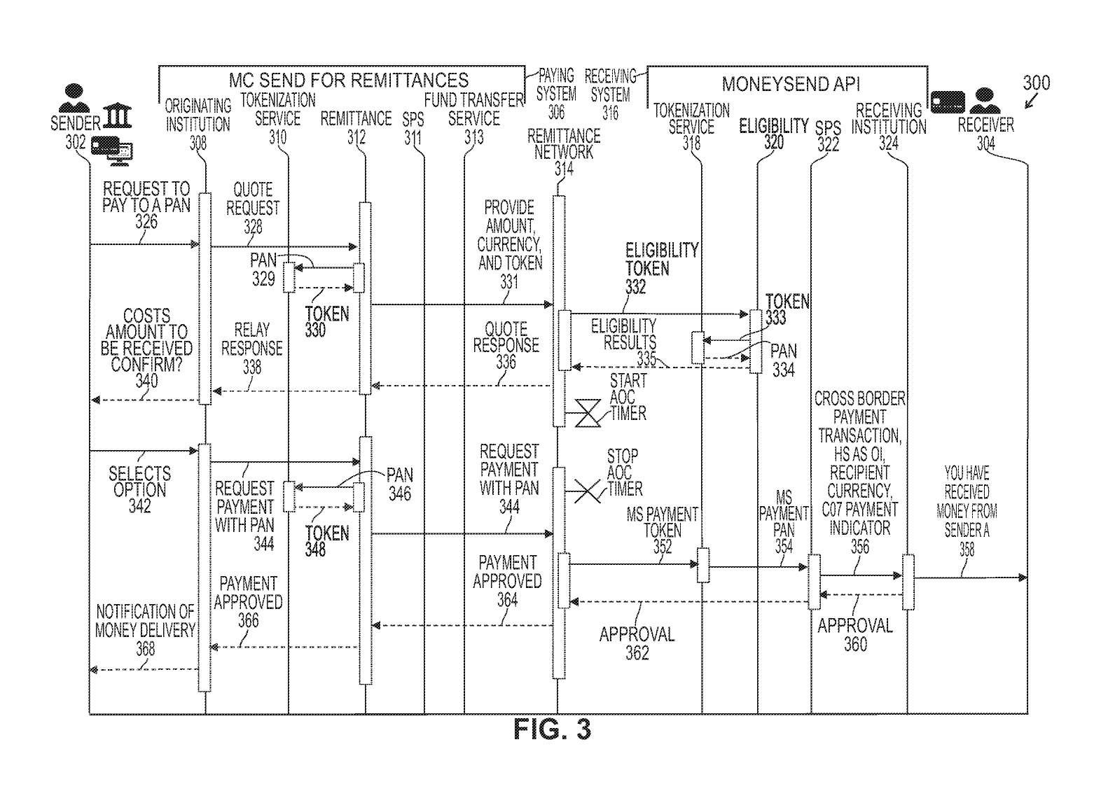

FIG. 3 is a flow diagram 300 illustrating another process for transmitting a remittance payment from a sender 302 having a payment card account to a receiver or recipient 304 who also has a payment card account in accordance with processes described herein. In this example, both the sender and the recipient are associated with institutions that are members of a remittance system which utilizes the remittance network 314 to conduct remittance transactions. Members of the remittance system have an agreement or contract to participate as a sender and/or as a receiver. For example, a sender institution (such as the originating institution 308 of FIG. 3) has an agreement to act as a sender of remittances, and the receiver institution 324 has an agreement to be a payment card account issuer (for example, an issuer of MasterCard™ brand payment card accounts) and to receive remittance transactions (which may be, for example, MasterCard MoneySend™ transactions). In some embodiments, a unique identifier service is provided from within an application, and it operates to enable processing of a remittance transaction to a primary account number (PAN) of the recipient 304.

Referring again to FIG. 3, the components of the remittance system include a paying system 306 operably connected to a receiving system 316 via a remittance network computer 314. In particular, the paying system 306 includes an originating financial institution (FI) 308, a tokenization service 310, and a remittance service 312. In some embodiments, a secure payment system application 311 and a funds transfer service application 313 may also be utilized. The receiving system 316 includes a tokenization service 318, an eligibility service 320, a secure payment system (SYS) application 322, and a receiving financial institution (FI) 324 that holds the payment card account of the recipient 304. In some embodiments, the tokenization service is provided by a payment card transaction processing system (such as the BankNet™ system operated by MasterCard International Incorporated), and is configured to serve the Remittance Network 314 to conduct remittance transactions in accordance with the processes described herein.

In an implementation, the sender (or cardholder) 302 transmits 326 a remittance request including the recipient's 16-digit account number (PAN) as the receiving account (with an account type of PAN) to the sender FI or originating FI 308, which receives it and then submits a quote request 328 to the remittance service 312. The quote request 328 is necessary because, especially for the case of a cross-border remittance transaction, the sender institution must be informed of the costs associated with the transaction, and also must be informed of the amount of money the recipient will receive in the receiver's or recipient's home currency. Continuing with the flow of data, the remittance service 312 recognizes the receiving account type as a PAN and then calls 329 the tokenization or unique identification service 310 and provides the PAN for generation of a unique identification number for further processing. In some implementations, the unique identifier is generated by the unique identifier service (or token service) 310 in accordance with the process described above, for example with reference to FIGS. 2A and 2B. The tokenization service 312 then transmits 330 the token or unique identifier to the remittance service 312, which then transmits 331 the unique identifier along with the currency type and monetary amount of the remittance to the remittance network computer 314 for eligibility processing.

The remittance network computer 314 receives the unique identifier along with the currency type and monetary amount of the remittance, and then transmits that information to the eligibility service 320 of the receiving system 316 to determine whether or not the recipient's account is eligible for receiving the remittance transaction. The eligibility service 320 transmits 333 the token with the unique identifier to the tokenization service 318, which translates the unique identifier back into the PAN of the recipient and then transmits 334 the PAN back to the eligibility service 320 for making a determination regarding whether or not the recipient's PAN is eligible for the remittance transaction. If so, the eligibility service transmits 335 a positive eligibility message to the remittance network 314, which then processes the remittance payment request. In particular, the remittance network 314 generates and transmits 336 a quote response to the remittance service 312 of the paying system 306, starts a timer (application of a velocity limit) with respect to the token portion of the unique identifier, and stores the unique identifier with the payment details in a memory (which may be a secure storage device and/or remittances database (not shown)). The timer counts down from a value that is indicative of how long the quote is valid. The remittance service 312 then relays 338 the quote response to the originating FI 308 which then presents 340 it to the sender 302 (for example, the originating FI may transmit the quote response to a consumer device, such as a tablet computer, for review by the sender). The quote response may include, but is not limited to, the remittance amount (requested by the sender), information concerning the costs of processing the remittance transaction that the sender will be responsible for paying, one or more options that can be selected by the sender, plus a request for confirmation from the sender indicating a willingness to proceed with the remittance transaction. The options presented to the sender (the cardholder) may include one or more methods or ways that the sender can use to pay the fees associated with the remittance. For example, the sender may choose to pay the fees on top of (or in addition to) the amount of the remittance, or may choose to have the fees taken out of the remittance amount being sent (so that the recipient receives less money), or may choose to have the fees deducted from a separate financial account of the sender (which may be held by the originating institution, for example).

The sender 302 contacts 342 the originating FI 308 with one or more option selections regarding the remittance transaction (such as a selection of exactly how to pay for the transaction), and then the originating FI transmits 344 the remittance transaction payment request with the same recipient's PAN to the remittance service 312, which provides 346 the PAN to the tokenization or unique identifier service 310 for processing. The remittance service then receives 348 a unique identifier, formats a remittance payment request which includes the token as a remittance payment transaction, and then transmits 350 it to the remittance network 314 for processing. The remittance network 314 recognizes the payment request by a quote identifier tied to the given quote for the remittance transaction and stops the timer, and then transmits 352 the formatted remittance payment request with the unique identifier to the tokenization service 318. (In some embodiments, if the timer has expired then the remittance network 314 rejects the payment request, and sends a message to the sender to that effect). The tokenization service 318 utilizes the information (data portions) that make up the unique identifier to look up the original 16-19 digit PAN of the recipient (for example, in a cardholder database (not shown)). The tokenization service 318 then transmits 354 the payment request which includes the recipient's PAN to the secure payment system (SPS) 322 which translates the application programming interface call (API call) into a network financial message that can be read by the receiving issuer. The SPS then transmits 356 the payment request which includes the PAN to the receiving FI 324 for processing.

In some embodiments, the recipient FI 324 transmits 358 a remittance transaction message to the recipient 304, and also transmits 360 an approval message to the SPS 322, which relays 362 the approval message to the remittance network computer 314. The remittance network computer 314 receives the remittance transaction approval message, updates its systems with the information contained therein, replaces the PAN with the originally provided unique identifier, and then transmits 364 a payment approved message including the unique identifier to the remittance service 312 of the payment system 306. The remittance service 312 then relays 366 the payment approved message to the originating FI 308, which notifies 368 the sender 302 that the money has been delivered to the recipient (i.e., the originating FI transmits a remittance transaction successful notification to an electronic device, such as a laptop computer, of the sender), and the process ends.

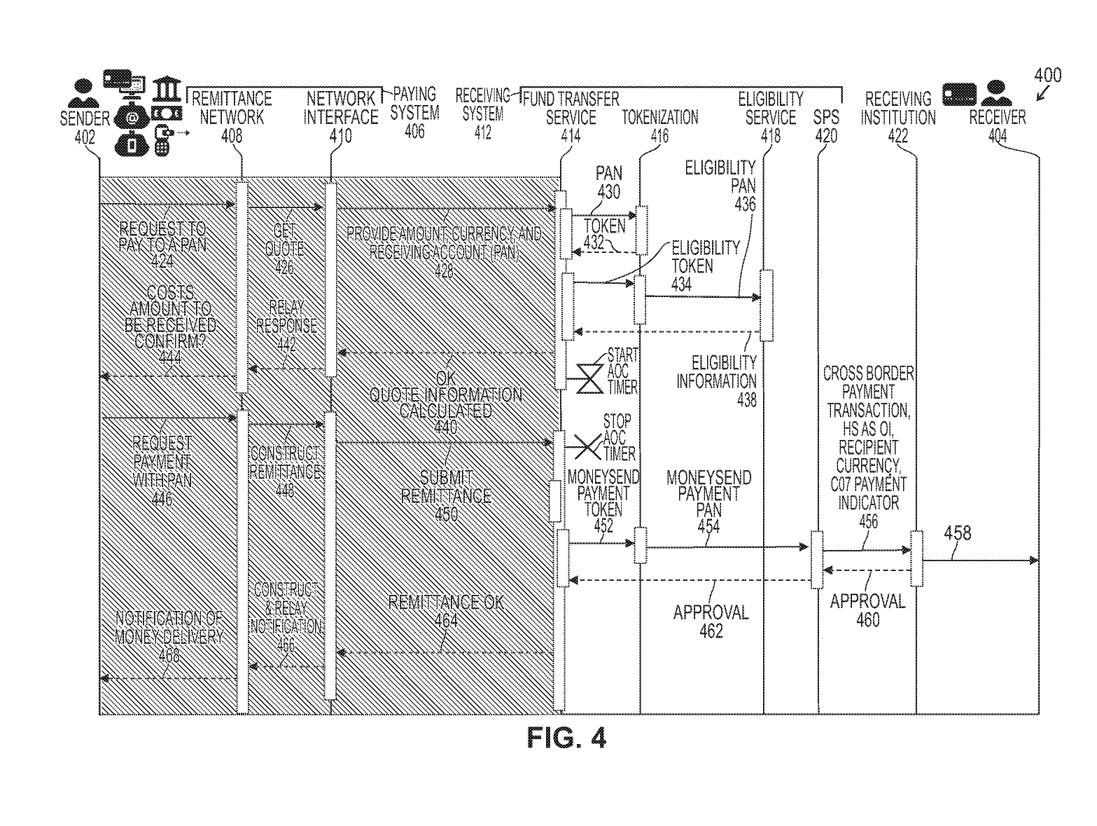

FIG. 4 is a flow diagram 400 illustrating a process for transmitting a remittance payment from a sender 402 having a payment card account to a recipient 404 who also has a payment card account in accordance with the disclosure. In this example, the sender is a member of the remittance transaction system and utilizes the remittance network 408 to transmit a remittance transaction to a recipient 404 who has a payment card account but who is not a member (but he receiving institution is a payment processing system issuer, for example, a MasterCard™ Issuer). In some embodiments, a unique identifier service is provided from within an application and operates to process a remittance transaction to a primary account number (PAN) of the recipient 404 in accordance with processes disclosed herein.

Referring again to FIG. 4, a paying system 406 communicates with a receiving system 412 via a remittance network interface 410. In particular, the paying system 406 includes a remittance network 408 and a remittance interface 410. The receiving system 412 includes a funds transfer service 414, a tokenization service 416, an eligibility service 418, a secure payment system (SYS) application 420, and a receiving financial institution (FI) 422 that holds the payment card account of the recipient 404.

Referring again to FIG. 4, in this implementation the sender (or cardholder) 402 transmits 424 a remittance request to the remittance network 408 to pay to a primary account number (PAN) of the recipient. Thus, the remittance request includes the recipient's 16-digit account number (PAN) as the receiving account (with an account type of PAN), and the remittance network then transmits 426 a quote request to the network interface 410. The network interface then transmits 428 information regarding the remittance transaction including the currency type, the monetary amount of the remittance, and the recipient's account number (PAN) to a funds transfer service 414 of the receiving system 412 for eligibility processing to first determine whether or not the recipient's account is eligible for receiving the remittance transaction. Next, the funds transfer service 414 transmits 430 the recipient's PAN to the tokenization service 416 which then generates a unique identifier and transmits 432 the unique identifier back to the funds transfer service 414. The funds transfer service 414 then transmits the unique identifier as an eligibility token to the tokenization service 416 which looks up the PAN of the recipient (for example, in a cardholder database (not shown)) and transmits 436 it to the eligibility service 418 which determines whether or not the recipient's PAN is eligible for the remittance transaction. The eligibility service 418 then transmits 438 eligibility information to the funds transfer service 414 which next processes the remittance payment request. In particular, the funds transfer service 414 generates a quote response and transmits 440 the quote response to the network interface 410 of the paying system 406, starts a timer (application of a velocity limit) with respect to the length of time that the quote is valid, and stores the unique identifier with the payment details in a memory (which may be a secure storage device and/or remittances database (not shown)). The network interface 410 relays 442 the quote response to the sender 402 (for example, the network interface may transmit the quote response to a consumer device, such as a Smartphone, for review by the sender). The quote response may include, but is not limited to, the remittance amount (requested by the sender), information concerning the costs of processing the remittance transaction that the sender will be responsible for paying, one or more options that can be selected by the sender (as explained earlier), plus a request for confirmation from the sender indicating a willingness to proceed with the remittance transaction.

Referring again to FIG. 4, the sender 402 transmits 446 a payment request to the remittance network 408 that may include selection of one or more options regarding the remittance transaction, and then the remittance network formats a remittance payment request which includes the token as a remittance payment transaction. The remittance network then transmits 448 the formatted remittance payment request to the network interface 410 which then submits 450 it to the funds transfer service 416 of the receiving system 412 for processing. The funds transfer service 414 recognizes the remittance payment request and stops the timer if the quote is still valid, and then transmits 452 the formatted remittance payment request with the unique identifier to the tokenization service 416. The tokenization service 416 utilizes the information that makes up the unique identifier to look up the original 16-19 digit PAN of the recipient. The tokenization service 416 then transmits 454 the remittance payment request which now includes the recipient's PAN to the secure payment system (SPS) 420 which functions to translate an application programming interface call (API call) into a network financial message that can be read by the receiving issuer 422. The SPS 420 then transmits 456 the remittance payment request which includes the recipient's PAN to the receiving FI 422 for processing.

In some embodiments, the recipient FI 422 transmits 458 a remittance transaction received message to the recipient 404, and also transmits 460 an approval message to the SPS 420, which relays 462 the approval message to the funds transfer service 414. The funds transfer service 414 receives the remittance transaction approval message, updates its systems with the information contained therein, replaces the PAN with the originally provided unique identifier, and then transmits 464 a payment approved message (or successful remittance message) which may include the unique identifier to the network interface 410 of the payment system 406. The network interface 410 then constructs a notification message and then relays 466 the notification message to the remittance network 408, which notifies 468 the sender 402 that the remittance (the money) has been delivered to the recipient (i.e., the remittance network computer transmits a remittance transaction successful notification to an electronic device, such as a cell phone, of the sender).

The embodiments described herein provide a technical solution for a remittance network to the problem of how to generate and/or provide a unique identifier to replace a cardholder's PAN that reduces the PCI compliance requirements associated with accepting, processing, and storing PAN data, and that also contains enough consistent information to allow cardholder account level controls and/or tracking to be accomplished by the remittance network. In addition, processes disclosed herein may be used with already existing transaction processing systems that are currently installed and in use by payment networks, issuer FIs, acquirer FIs and the like, and which can be used for cross-border remittance transaction purposes wherein AML and/or know your customer (KYC) requirements are enforced.

Any flow charts and descriptions thereof herein should not be understood to prescribe a fixed order of performing the method steps described therein. Rather, the method steps may be performed in any order that is practicable, including combining one or more steps into a combined step.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method for conducting a remittance transaction comprising:
receiving, by a sending remittance system computer from an originating financial institution (FI) computer associated with a sender, a remittance payment request comprising a remittance amount, a currency type, and a primary account number (PAN) of a recipient;
validating, by the sending remittance system computer, the remittance payment request and identifying a recipient account as a payment card account;
transmitting, by the sending remittance system computer, the recipient's PAN to a unique identifier service computer;
receiving, by the sending remittance system computer from the unique identifier service computer, a unique identifier comprising a static portion and a unique identification portion;
generating, by the sending remittance system computer, a remittance payment transaction request that comprises the static portion and unique identification portion, the remittance amount, and the currency type; and
transmitting, by the sending remittance system computer to a network partner system computer, the remittance payment transaction request.

2. The method of claim 1, wherein the static portion of the unique identifier comprises a bank identification number (BIN) portion, a four digits portion equivalent to the last four digits of the recipient's PAN, a version number portion, and a token based on the recipient's PAN.

3. The method of claim 1, wherein the unique identification portion is generated by a random number generator.

4. The method of claim 1, wherein the unique identification portion is based on a time stamp associated with the remittance transaction request.

5. The method of claim 1, further comprising:
receiving, by the sending remittance system computer from the network partner system computer, a positive remittance response comprising the unique identifier when a receiving financial institution (FI) associated with the recipient's PAN authorizes receipt of payment of the remittance; and
transmitting, by the sending remittance system computer to the originating FI computer, the positive remittance response.

6. The method of claim 1, further comprising:
receiving, by the network partner system computer from the payment transmission system computer, the remittance payment transaction request;
transmitting, by the network partner system computer to a receiving system computer, an eligibility request that includes the unique identifier;
receiving, by the network partner system computer from the receiving system computer, eligibility information;
determining based on the eligibility information that the recipient's account is eligible for the remittance transaction;
determining, by the network partner system computer, that the remittance transaction amount is within anti-money laundering (AML) limits for the recipient's account;
logging, by the network partner system computer, remittance transaction information in association with the unique identifier; and
transmitting, by the network partner system computer, the remittance request to the receiving system computer.

7. The method of claim 6, further comprising:
receiving, by the network partner system computer from the receiving system computer, a positive remittance response when a receiving financial institution (FI) associated with the recipient's PAN authorizes receipt of payment of the remittance;
logging, by the network partner system computer, the positive remittance response; and
transmitting, by the network partner system computer to the sending remittance system computer, the positive remittance response.

8. The method of claim 1, further comprising:
receiving, by a receiving system computer from the network partner system computer, a payment request with the unique identifier;
transmitting, by the receiving system computer to a unique identifier service, the unique identifier;
receiving, by the receiving system computer from the unique identifier service, the recipient's PAN;
identifying, by the receiving system computer, an issuer financial institution (FI) computer associated with the recipient's PAN;
replacing, by the receiving system computer, the unique identifier in the payment request with the recipient's PAN;
transmitting, by the receiving system computer to the issuer FI computer, the payment request including the recipient's PAN;
receiving, by the receiving system computer from the issuer FI computer, a remittance transaction approval response when the issuer FI approves the payment request; and
transmitting, by the receiving system computer to the network partner system computer, the remittance transaction approval response.

9. The method of claim 8, further comprising, subsequent to receiving the remittance transaction approval response, logging the transaction approval response in a database.

10. A remittance payment system comprising:
a network partner system computer;
a sending remittance system computer operably connected to the network partner system computer;
a receiving system computer operably connected to the network partner system computer;
an originating financial institution (FI) computer operably connected to the sending remittance system computer; and
an issuer FI computer operably connected to the receiving system computer;
wherein the sending remittance system computer comprises a storage device storing instructions configured to cause the sending remittance system computer to:
receive from the originating financial institution (FI) computer a remittance payment request from a sender, the remittance request comprising a remittance amount, a currency type, and a primary account number (PAN) of a recipient;
validate the remittance payment request and identify a recipient account as a payment card account;
transmit the recipient's PAN to a unique identifier service computer;
receive a unique identifier comprising a static portion and a unique identification portion from the unique identifier service computer;
generate a remittance payment transaction request that comprises the static portion and unique identification portion, the remittance amount, and the currency type; and
transmit the remittance payment transaction request to a network partner system computer.

11. The system of claim 10, wherein the storage device stores further instructions configured to cause the sending remittance system computer to:
receive a positive remittance response from the network partner system computer, the positive remittance response comprising the unique identifier when the receiving financial institution (FI) associated with the recipient's PAN authorizes receipt of payment of the remittance; and
transmit the positive remittance response to the originating FI computer.

12. The system of claim 10, further comprising a storage device associated with the network partner system computer that stores instructions configured to cause the network partner system computer to:
receive a remittance payment transaction request from the payment transmission system computer;
transmit an eligibility request to the receiving system computer that includes the unique identifier;
receive eligibility information from the receiving system computer;
determine, based on the eligibility information, that the recipient's account is eligible for the remittance transaction;
determine that the remittance transaction amount is within anti-money laundering (AML) limits for the recipient's account;
log remittance transaction information in association with the unique identifier; and
transmit the remittance request to the receiving system computer.

13. The system of claim 12, wherein the storage device associated with the network partner system computer stores further instructions configured to cause the network partner system computer to:
receive a positive remittance response when a receiving financial institution (FI) associated with the recipient's PAN authorizes receipt of payment of the remittance;
log the positive remittance response; and
transmit the positive remittance response to the sending remittance system computer.

14. The system of claim 10, further comprising a storage device associated with the receiving system computer that stores instructions configured to cause the receiving system computer to:
receive a payment request with the unique identifier from the network partner system computer;
transmit the unique identifier to a unique identifier service;
receive the recipient's PAN from the unique identifier service;
identify an issuer financial institution (FI) computer associated with the recipient's PAN;
replace the unique identifier in the payment request with the recipient's PAN;
transmit the payment request including the recipient's PAN to the issuer FI computer;
receive a remittance transaction approval response from the issuer FI computer when the issuer FI approves the payment request; and
transmit the remittance transaction approval response to the network partner system computer.

15. The system of claim 14, wherein the storage device associated with the receiving system computer stores further instructions configured to cause the receiving system computer to, subsequent to receiving the remittance transaction approval response, log the transaction approval response in a database.
